(19) United States
(12) Patent Application Publication
(10) Pub. No.: US 2019/0084108 A1
(43) Pub. Date: Mar. 21, 2019

(54) MACHINE TOOL FOR MACHINING A WORKPIECE

(71) Applicant: DECKEL MAHO Seebach GmbH, Seebach (DE)

(72) Inventors: Fabian Suckert, Erfurt (DE); Engel Andre, Brotterode (DE); Petsch Rene, Gotha (DE)

(21) Appl. No.: 16/131,888

(22) Filed: Sep. 14, 2018

(30) Foreign Application Priority Data
Sep. 17, 2017 (DE) 10 2017 216 446.8

(51) Int. Cl. B23Q 5/12; B23Q 1/48

(52) U.S. Cl. CPC B23Q 5/12; B23Q 1/4804

(57) ABSTRACT

The present invention relates to a machine tool 100 for machining a workpiece, said machine tool 100 having the following: a support portion 30 on which at least one vertical guide 18, 32 is disposed; a machining unit 10 for machining a workpiece on the machine tool 100, said machining unit 10 being guided so as to be vertically movable on the at least one vertical guide 18, 32 of the support portion 30; a drive mechanism 20 having at least one drive 21 and at least one gearbox 22, said drive mechanism 20 being specified for driving a relocation of the machining unit 10 in the vertical direction along the at least one vertical guide 18, 32 of the support portion 30, wherein the machining unit is suspended from one or a plurality of gearbox portions of the at least one gearbox 22 of the drive mechanism 20 in such a manner that the centre of gravity 101 of the machining unit 10 conjointly with an effective point 12 of the suspension 11 of the machining unit 10 on the drive mechanism 20 is disposed in a common vertically oriented straight line 23.

The present invention relates to a machine tool for machining a workpiece.

### BACKGROUND TO THE INVENTION

The tool-supporting machining unit represents one of the most essential component parts of a machine tool, in particular having a tool-supporting work spindle. Said tool-supporting machining unit is assigned an important task in terms of the precision of the parts to be made, since said tool-supporting machining unit by means of the tool supported thereby carries out the material-subtracting processes directly on the workpiece. It is therefore particularly important that the tool-supporting machining unit applies the contour described by predefined parameters as precisely as possible to the workpiece.

Typically, numerically controllable axes which have a respective precision and reproducibility are substantially responsible for the above. However, the parameters controlling the axes have to be corrected in a corresponding manner, for example depending on the environmental conditions, the weight of the workpiece etc.

Moreover, the construction of the machine tool per se can have a substantial influence on the “degree” of the correction of the controlling parameters, for example when masses within the machine tool are repositioned by actuating the numerically controllable axes. This can lead to comparatively large deviations in the real position of the tool of the machining unit that is received in the work spindle, wherein these deviations to some degree can only be corrected with difficulty and with the aid of complex trajectory corrections of the numerically controllable axes.

### SUMMARY OF THE INVENTION

It is therefore an object of the present invention to provide a machine tool by way of which the above problem can be avoided, in particular such that a facilitated trajectory correction is enabled, and the precision of the machining process is simultaneously improved.

In order for this object to be achieved, a machine tool for machining a workpiece according to claim 1 is proposed according to the invention. The dependent claims relate to advantageous exemplary embodiments of the machine tool according to the invention.

The machine tool according to the invention for machining a workpiece has: a support portion on which at least one vertical guide is disposed; a machining unit for machining a workpiece on the machine tool, said machining unit being guided so as to be vertically movable on the at least one vertical guide of the support portion; a drive mechanism having at least one drive and at least one gearbox, said drive mechanism being specified for driving a relocation of the machining unit in the vertical direction along the at least one vertical guide of the support portion, wherein the machining unit is suspended from one or a plurality of gearbox portions of the at least one gearbox of the drive mechanism in such a manner that the centre of gravity of the machining unit conjointly with an effective point of the suspension of the machining unit on the drive mechanism is disposed in a common vertically oriented straight line.

On account of the construction of the machine tool according to the invention in which the centre of gravity of the machining unit is placed such that said centre of gravity lies either within the effective point of the suspension or on a vertically oriented straight line which runs through the effective point, it is enabled that either a negligibly minor torque, for example in the case of the vertical guide, or a consistent torque, for example in the case of the horizontal guides, acts on the vertical and horizontal guides of the machining unit, said torque being generated by the mass of the machining unit and the spacing from the effective point of the suspension.

On account of this measure, a facilitated trajectory correction of the respective numerically controllable axes can be performed, since the vertical position of the machining unit which significantly influences the torques arising in the guides in a conventional construction of a machine tool has to be taken into consideration to a substantially lesser degree. This is particularly advantageous since said constructive measure leads to an enhanced geometric precision in the actuation of the machining unit and thus to an enhanced precision of the workpiece machined, since the influence of the mass of the machining unit on the guides remains constant.

On account of the optimization of the suspension of the machining unit, one problem in the correction of the trajectories of the relocating parts of a machine tool has been able to be avoided or simplified to substantially consistent values, respectively, such that apart from a simpler trajectory correction an enhanced precision in the manufacturing of the workpiece has been able to be achieved.

One advantageous refinement of the machine tool according to the invention lies in that the effective point of the suspension in the case of one gearbox is disposed in the suspension per se, and in the case of a plurality of gearboxes is disposed substantially in the centre of individual suspensions which form the suspension in the case of a plurality of gearboxes.

It is ensured on account thereof that the centre of gravity of the machining unit does not generate any torque or at least a consistent torque in the case of the vertical and horizontal guides of the machine tool, independently of the vertical position of the machining unit.

One further advantageous refinement of the machine tool according to the invention lies in that the machining unit is suspended from the one or the plurality of gearbox portions of the at least one gearbox of the drive mechanism in such a manner that a consistent torque acts on the support portion during the relocation in the vertical direction.

The machine tool according to the invention can furthermore be advantageously refined in that the machining unit is suspended from the one or the plurality of gearbox portions of the at least one gearbox of the drive mechanism in such a manner that substantially no torque acts on the at least one vertical guide of the support portion during the relocation in the vertical direction.

Both refinements enable a lesser degree of correction of the numerically controlled axes by virtue of variable loads and torques which are created by the repositioning of masses within the machine tool, in particular of the relocation of the machining unit.

The machine tool according to the invention can moreover be advantageously refined in that the drive mechanism is disposed in such a manner that the drive mechanism maintains the position thereof relative to the support portion during the relocation of the machining unit, and the position of the effective point of the suspension relative to the machining unit remains substantially consistent.

One advantageous refinement of the machine tool according to the invention lies in that the drive mechanism is disposed in such a manner that the drive mechanism maintains the position thereof relative to the machining unit during the relocation of the machining unit, and the position of the effective point of the suspension relative to the support portion remains substantially consistent.

It can moreover be advantageous for the machine tool according to the invention to be refined in such a manner that both the drive mechanism as well as the effective point of the suspension are disposed in such a manner that the two former maintain the position thereof relative to the support portion during the relocation of the machining unit.

The machine tool according to the invention can furthermore be advantageously refined in that both the drive mechanism as well as the effective point of the suspension are disposed in such a manner that the two former maintain the position thereof relative to the machining unit during the relocation of the machining unit.

The four potential design embodiments of the suspension and of the positioning of the drive mechanism mentioned are to be understood as exemplary variants which can be applied depending on the application and the requirements set for the machine tool.

One advantage can be, for example, that the drive of the drive mechanism, which simultaneously represents a heat source, remains on the support or the support portion, respectively, of the machining unit, while the effective point or a suspension point of the suspension, respectively, is relocated conjointly with the machining unit. On account thereof, a heat source (drive of the drive mechanism) can advantageously be kept out of the machining region that is more proximal to the workpiece, such that the heating action of the drive would influence the machining processes only to a minor degree.

By contrast, it can also be advantageous for the drive of the drive mechanism to be guided conjointly with the machining unit so as to increase the mass of the machining unit. On account thereof, the machining unit could react with somewhat more inertia to forces that suddenly arise in the machining process of the workpiece, which in turn can positively influence the result of the machining process.

The machine tool according to the invention can be advantageously refined in that the effective point of the suspension and/or the centre of gravity of the machining unit move/moves along the vertically oriented straight line during the relocation of the machining unit.

It can be ensured on account thereof that the conditions of the torques acting on the guides of the machining unit do not vary to any particular degree, independently of the vertical position of the machining unit. Furthermore, the complexity in terms of correcting the numerically controllable axes can be significantly reduced on account thereof.

Moreover, the machine tool according to the invention can be advantageously refined in that the drive mechanism is configured as a self-locking drive mechanism.

On account of a self-locking drive mechanism it is possible for the machining unit to be positioned along the vertical axis, wherein no further securing measures or locking mechanisms are required in this position since the drive mechanism, without being moved by the drive, does not permit any further adjustment of the position of the machining unit.

The machine tool according to the invention can moreover be advantageously refined in that the drive mechanism comprises at least one screw drive, preferably at least one ball screw drive.

A screw drive is known as an application of a self-locking device mechanism, said screw drive permitting by virtue of a respective thread pitch a readjustment of the vertical position of the machining unit only when the thread-bearing element (a threaded element, for example a threaded bar having a ball thread, a trapezoidal thread, or another form of thread) is driven in a corresponding manner by an electric, pneumatic or hydraulic drive.

An advantageous refinement of the machine tool according to the invention lies in that in the case of one gearbox the at least one vertical guide of the machining unit is disposed in such a manner that the centre of gravity of the machining unit is displaced in a manner substantially concentric with a threaded bar of the screw drive, in particular along the vertically oriented straight line, in the relocation of the machining unit.

Furthermore, the machine tool according to the invention can be advantageously refined in that the threaded bar is disposed so as to be axial to the vertically oriented straight line.

Should the drive mechanism have, for example, one drive and one gearbox for relocating the machining unit along the vertical direction, it can be extremely advantageous for the centre of gravity of the machining unit to be placed directly in the point of the suspension (suspension point). The reason therefor lies in that the centre of gravity would now lie directly in the cross section of the threaded bar, which would therefore stress the threaded bar exclusively in terms of traction or compression, on the one hand, and simultaneously would substantially free the vertical guide of the machining unit of receiving a torque which is generated by virtue of the spacing of the centre of gravity of the machining unit from the guide line of the guides. Significantly more precise guiding of the machining unit in the vertical direction can be enabled on account thereof, since the forces impinging on the guide are significantly reduced.

The machine tool according to the invention can be advantageously refined in that the drive mechanism comprises at least one gear-and-rack combination, preferably at least one helical-cut gear-and-rack combination.

Furthermore, the drive mechanism can be embodied in the form of a rack having a respective driving gear wheel, wherein this embodiment does not have the self-locking properties of a screw drive.

The machine tool according to the invention can furthermore be advantageously refined in that in the case of one gearbox the at least one vertical guide of the machining unit is disposed in such a manner that the centre of gravity of the machining unit is guided substantially at the contact point of the pitch circle of the gear wheel and the pitch line of the rack in the relocation of the machining unit.

The conditions at this point are very similar to those of the threaded bar, such that it can be extremely advantageous, for example when the drive mechanism has one drive and one gearbox for relocating the machining unit along the vertical direction, for the centre of gravity of the machining unit to be placed directly in the point of the suspension (the suspension point here is the contact point between the pitch circle of the gear wheel and the pitch line of the rack). The rack here would be stressed exclusively in terms of traction or compression, and the vertical guide of the machining unit would simultaneously be freed of receiving a torque which is generated by virtue of the spacing of the centre of gravity of the machining unit from the guide line of the guides. Significantly more precise guiding of the machining unit in the vertical direction can be enabled on account thereof, since the forces impinging the guide are significantly reduced.

The machine tool according to the invention can be advantageously refined in that the machining unit comprises a spindle carrier that supports a work spindle.

Moreover, the machine tool according to the invention can be advantageously refined in that the spindle carrier comprises a pivot device for pivoting the work spindle about a pivot axis.

Diverse application potentials for the work spindle of the machining unit are enabled on account thereof, since said work spindle can be pivoted by the spindle carrier in a wide angular range, for example from +90° to −90° in relation to the vertical alignment of the work spindle, wherein the angular range can also be chosen so as to be partially larger. This may depend, for example, on the flexing behaviour of the supply lines to the work spindle.

It can furthermore be advantageous for the machine tool according to the invention to be refined in such a manner that the pivot axis is disposed perpendicular or oblique, preferably at an angle of 45°, in relation to a spindle axis of the work spindle.

On account thereof, the work spindle, or the tool receptacle of the work spindle, respectively, can be pivoted in an angular range from 0° to 90°, for example (in the case of a pivot axis that is set at 45° in relation to the spindle axis, for example).

A particularly advantageous refinement of the machine tool according to the invention results in that a pivotable portion of the spindle carrier which holds the work spindle and by way of which the work spindle is pivotable about the pivot axis is disposed in such a manner that a common centre of gravity of the pivotable portion and of the work spindle lies in the intersection point of the pivot axis and of the vertically oriented straight line.

On account thereof, the work spindle, or a pivotable portion of the spindle carrier, respectively, can be particularly advantageously pivoted without any repositioning of the centre of gravity of the machining unit taking place, since the common centre of gravity of the work spindle and of the pivotable portion, despite pivoting, is not repositioned. On account thereof, the influences of the torques generated by the moving masses of the machining unit acting on the guides can furthermore be kept constant or so as to be negligibly minor.

A further advantageous refinement of the machine tool according to the invention lies in that the support portion is configured as a machine stand that is disposed on a machine bed.

On account thereof, the machine support in the position thereof relative to the machine bed can be designed so as to be fixed, on account of which an actuation of the work spindle takes places directly on the machining unit.

The machine tool according to the invention can be advantageously refined in that the support portion comprises a slide portion that is mounted so as to be horizontally relocatable.

Moreover, the machine tool according to the invention can be advantageously refined in that the slide portion is disposed so as to be mounted on guides on a horizontally relocatable gantry construction of a gantry machine tool.

Advantageously, the design of the suspension of the machine tool according to the invention is able to be used on a relocatable gantry construction of a gantry machine tool.

On account of the machine tool according to the invention for machining a workpiece, the required corrections of the trajectories of the elements guided in each case were able to be simplified since the masses which are moved in the actuation of the machining unit either generate a consistent torque in the guides, or in specific guides indeed generate a negligibly minor torque, specifically independently of the vertical position of the machining unit, said vertical position otherwise having a significant influence on the torques acting therein. This can be advantageous when correcting the trajectories for the numerically controllable axes, this in turn leading to an increase in the manufacturing precision, since the geometric precision of the machine tool has been improved.

Further aspects and the advantages thereof, as well as advantages and more specialized potential embodiments of the aspects and features described above will be described hereunder by the descriptions and explanations pertaining to the appended figures, said descriptions and explanations not being intended to be interpreted as limiting in any way, however.

### BRIEF DESCRIPTION OF THE FIGURES

FIG. 1 schematically shows a perspective view of an embodiment of a machine tool according to the invention;

FIG. 2 schematically shows a lateral view of an embodiment of the machine tool according to the invention from FIG. 1;

FIG. 3 schematically shows a front view of an embodiment of the machine tool according to the invention from FIG. 1;

FIG. 4 schematically shows a detailed view of a suspension of the machining unit of the machine tool according to the invention from FIG. 1;

FIG. 5 schematically shows a detailed view of an embodiment of a machine tool according to the invention, having a screw drive as a gearbox for relocating the machining unit;

FIG. 6a schematically shows the effective point of the suspension when the drive mechanism has one gearbox (here a screw drive);

FIG. 6b schematically shows the effective point of the suspension when the drive mechanism has two gearboxes (here screw drives);

FIG. 6c schematically shows the effective point of the suspension when the drive mechanism has three gearboxes (here screw drives);

FIG. 7a schematically shows an embodiment of the machine tool according to the invention having a modified arrangement of the vertical guide; and

FIG. 7b schematically shows an embodiment of the machine tool according to the invention having a modified arrangement of the vertical guide in the lateral view.

### DETAILED DESCRIPTION OF THE FIGURES AND OF PREFERRED EXEMPLARY EMBODIMENTS OF THE PRESENT INVENTION

Examples or exemplary embodiments, respectively, of the present invention will be described in detail hereunder with reference to the appended figures. The same or similar elements in the figures herein may be referred to by the same reference signs. It is to be noted that the present invention is not limited or restricted, respectively, in any way to the exemplary embodiments described hereunder and to the embodied features thereof, but furthermore comprises modifications of the exemplary embodiments, in particular those modifications which by modifications of the features of the described examples, or by the combination of individual or a plurality of features of the described examples, respectively, are comprised by the scope of protection of the independent claims.

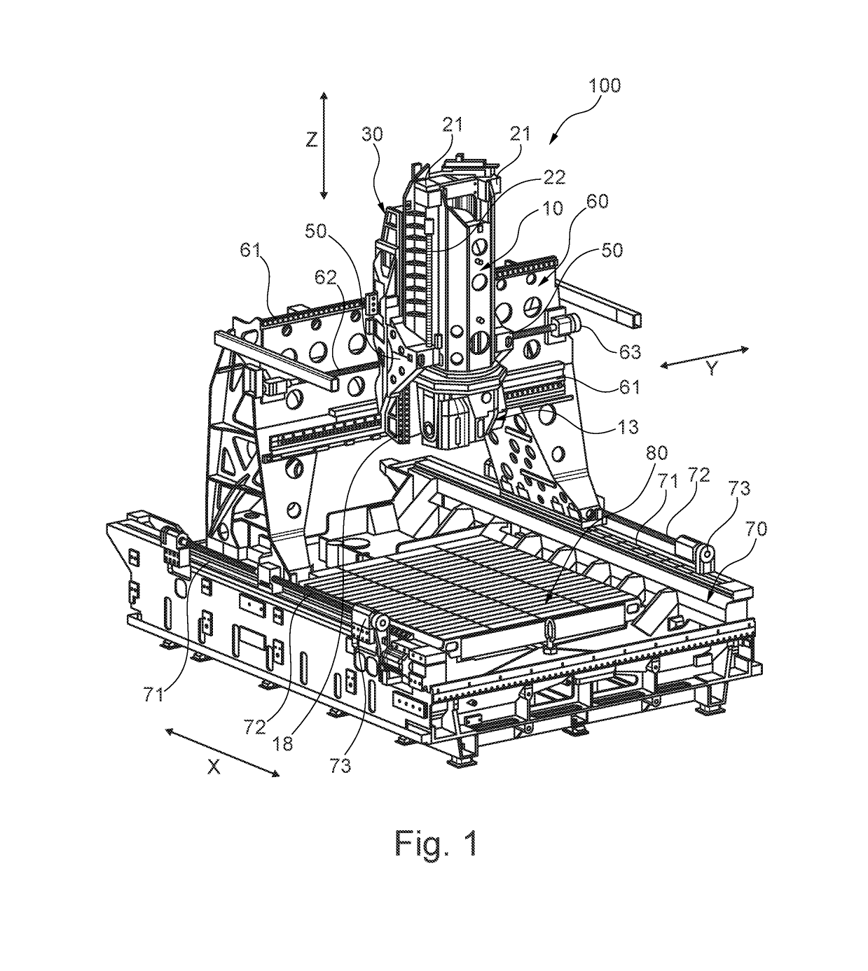

FIG. 1 in an exemplary schematic manner shows a perspective view of an embodiment of a machine tool 100 according to the invention. The machine tool 100 in an exemplary manner is of a gantry construction and has a machine bed 70 that can be set up on machine feet, a workpiece clamping table 80 on which workpieces can be clamped for machining being disposed on said machine bed 70 in an exemplary manner.

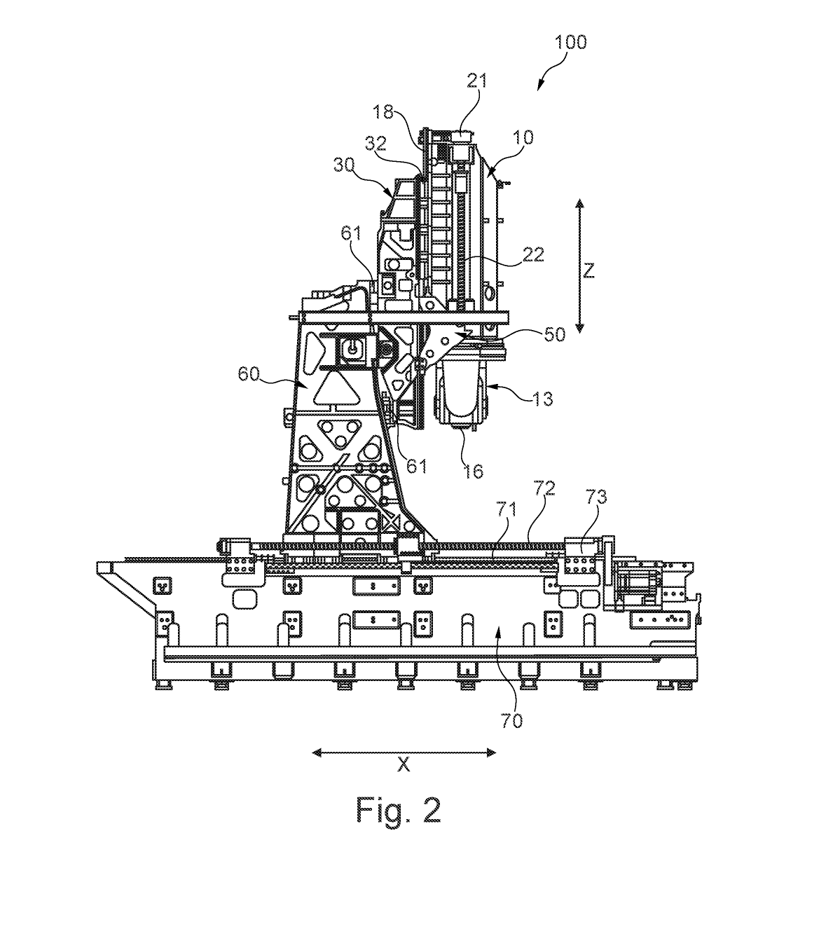

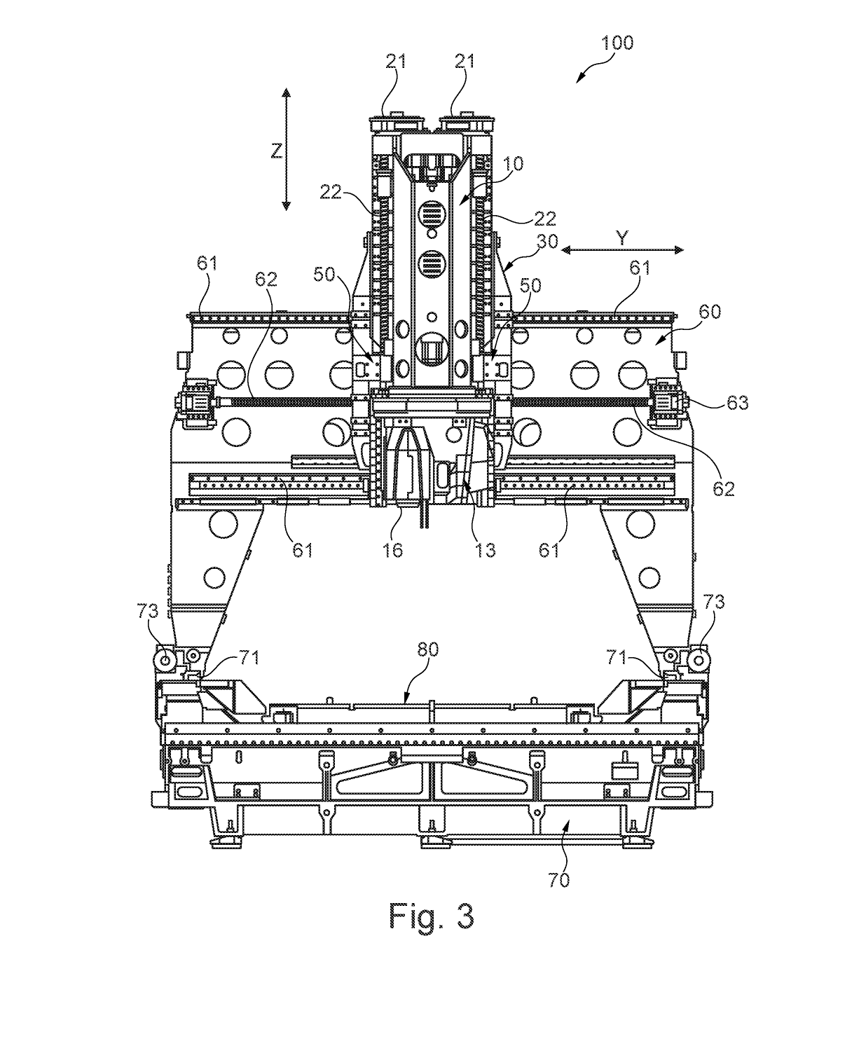

FIG. 2 in an exemplary schematic manner shows a lateral view of an embodiment of the machine tool according to the invention from FIG. 1. FIG. 3 in an exemplary schematic manner shows a front view of an embodiment of the machine tool according to the invention from FIG. 1.

Horizontal guides 71 are disposed in an exemplary manner horizontally in an X-direction on sides of the machine bed 70, a gantry stand 60 in an exemplary manner being guided so as to be horizontally relocatable in the X-direction on said horizontal guides 71. In order for the horizontal relocation of the gantry stand 60 to be driven, respective threaded bars 72 in an exemplary manner are disposed on both sides so as to be parallel with the guides 71, said threaded bars 72 in an exemplary manner being driven by drives 73.

Horizontal guides 61 are disposed in an exemplary manner horizontally in a Y-direction on the front side of the gantry stand 60, a support portion 30 in an exemplary manner being guided so as to be relocatable horizontally in the Y-direction on said horizontal guides 61. In order for the horizontal relocation of the support portion to be driven, a threaded bar 62 is disposed in an exemplary manner so as to be parallel with the guides 61, said threaded bar 62 in an exemplary manner being driven by a drive 63.

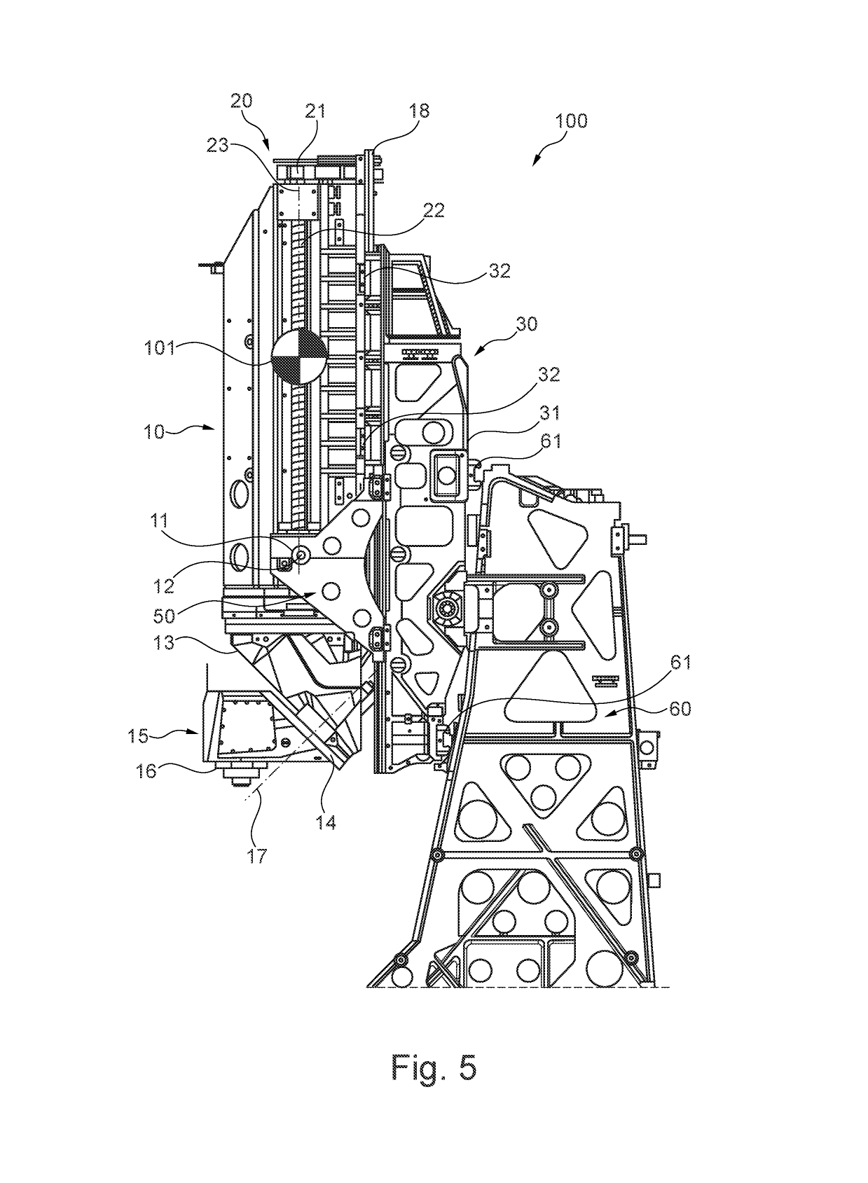

A machining unit 10 is held in an exemplary manner on the support portion 30 so as to be relocatable vertically in the Z-direction, and a spindle carrier unit 13 on which in an exemplary manner a tool-bearing work spindle 16 is disposed in an exemplary manner is held on the lower side of the machining unit. The spindle carrier unit 13 in an exemplary manner is moreover specified for being rotated about the vertical axis, and moreover the spindle carrier unit 13 in an exemplary manner furthermore has a horizontal pivot axis. In an alternative embodiment according to FIG. 5 the pivot axis can also be inclined at an oblique angle (for example by 45° in relation to the vertical rotation axis).

On account of the rotation axis and the pivot axis, two rotary degrees of freedom of the relative movement of the tool clamped in the work spindle 16 and of the workpiece clamped on the workpiece clamping table 80 are provided in addition to the three translatory degrees of freedom of the above-mentioned axes X, Y, and Z. The machine tool 100 in an exemplary manner is thus configured as a 5-axis machine tool.

The machining unit 10 in an exemplary manner is relocatable vertically by means of a vertical guide 18. However, the machining unit 10 according to the invention is not suspended from the support portion 30 by way of the guide 18, but in an exemplary manner from suspension portions 50 which in an exemplary manner are fastened to the support portion 30. Two threaded bars 22 in an exemplary manner are disposed vertically on the machining unit 10, said two threaded bars 22 being driven by drives 21 on the upper side of the machining unit 10.

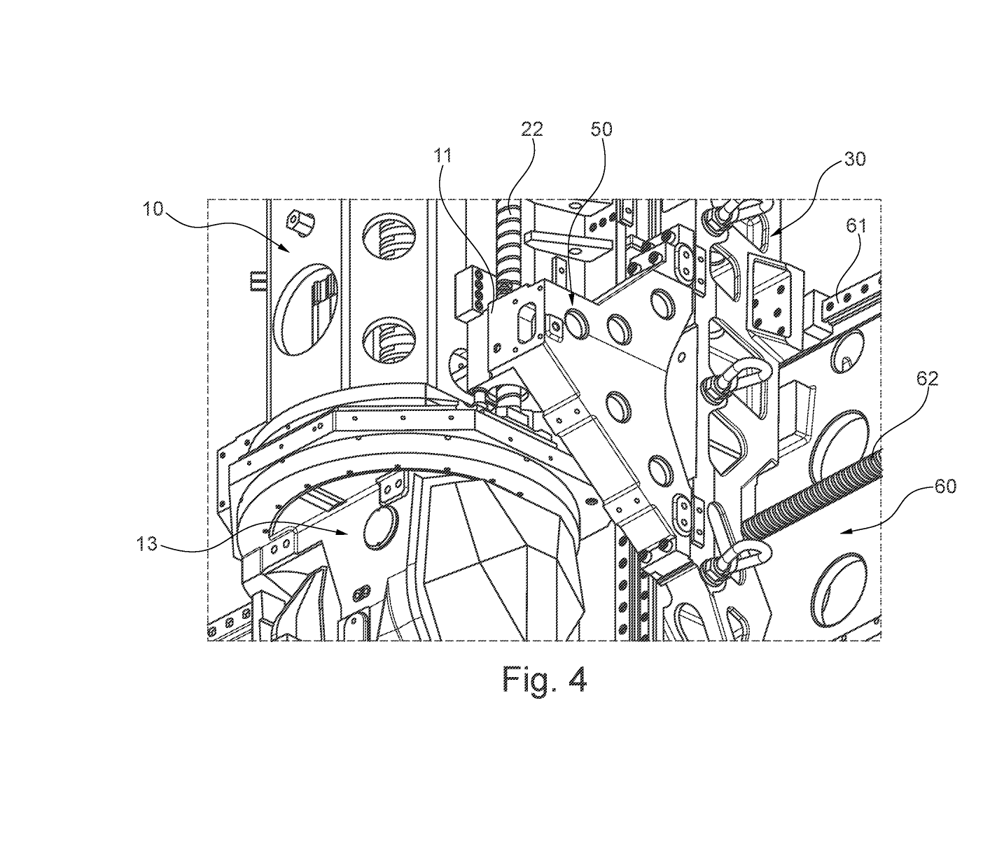

FIG. 4 in an exemplary schematic manner shows a detailed view of a suspension of the machining unit of the tool machine according to the invention from FIG. 1. The machining unit 10 in an exemplary manner is suspended from suspension points 11 on the suspension portions 50, in an exemplary manner in that the threaded bars 22 are suspended from the suspension points 11 on the suspension portions 50.

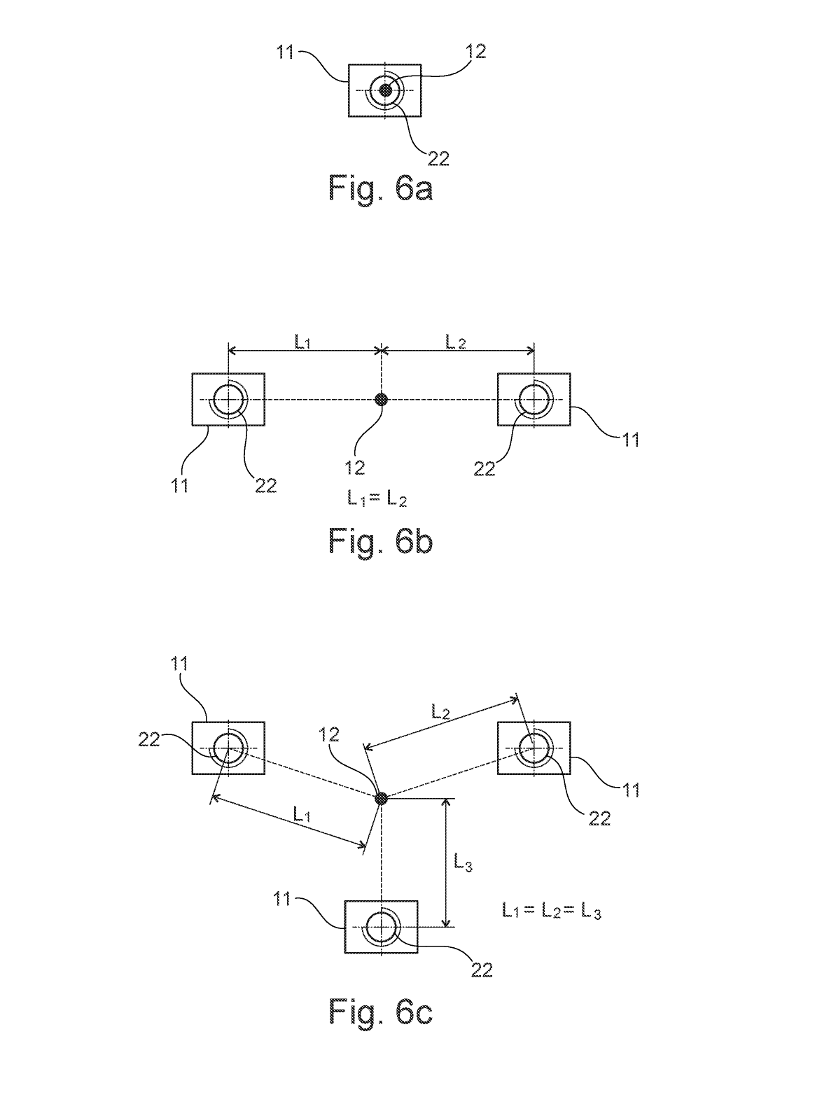

In a manner analogous to that of FIG. 6b, the suspension of the machining unit 10 herein is embodied having two suspension points 11 of the two suspension portions 50, said two suspension points 11 lying in a horizontal plane, wherein the effective point 12 of the suspension lies exactly between the suspension points 11 of the two suspension portions 50 (cf. to this end FIG. 6b). According to the invention, the machining unit 10 is designed in such a manner that the centre of gravity 101 of the entire machining unit 10 having the spindle carrier unit 13 in a horizontal straight line with the effective point 12 of the suspension lies exactly between the suspension points 11 of the two suspension portions 50 (cf. also the principle according to FIG. 5 and to the description).

The entire weight of the machining unit 10 having the spindle carrier unit 13, independently of the vertical Z-position of the machining unit 10, consequently bears at all times uniformly on the two suspension points 11 from which the threaded bars 22 are suspended. This has the advantageous effect that at all times the same weight is suspended from the suspension portions 50 in the relocation of the machining unit 10 in the Z-direction, and the same torque thus acts at all times on the support portion 30 by way of the suspension portions 50, independently of the Z-position of the machining unit 10. The vertical guide 18 of the machining unit 10 herein is at all times de-stressed on the guide elements 32 of the support portion, and substantially no torques arise on this guide.

Moreover, at all times the same torque acts on the support portion 30 by way of the suspension portions 50, independently of the Z-position of the machining unit 10, such that at all times the same torques act also on the horizontal guides 61 of the support portion 30 on the front side of the gantry portion 60, independently of the Z-position of the machining unit 10, such that the positioning precision has to be set once (for example, by way of a numerical compensation in the CNC machine controller), wherein however no compensation actions which depend on the Z-position have to be carried out, since the forces and torques that act from the support portion 30 on the gantry portion 60 are independent of the Z-position of the machining unit 10.

FIG. 5 in an exemplary schematic manner shows a detailed view of an embodiment of a machine tool 100 according to the invention, having a screw drive as the gearbox 22 for relocating the machining unit 10.

The machining unit 10 herein, in an exemplary manner is connected to the support portion 30 by way of a suspension 11 which in the vertical direction is readjusted by way of a rotatably mounted threaded bar (here in an exemplary manner as the gearbox 22) that is drivable by a drive 21 in such an exemplary manner that the position of the machining unit 10 relative to the support portion 30 can be readjusted in the vertical direction by rotating the threaded bar.

It can be seen herein in the embodiment as seen in FIG. 5 that the threaded bar when rotating follows the movement of the machining unit 10 in the vertical direction. This means that the drive 21 and the gearbox 22 of the drive mechanism 20 are fixedly connected to the machining unit 10, and the suspension 11 is fixedly connected to the support portion 30.

It can moreover be seen that the centre of gravity 101 of the machining unit 10 in an exemplary manner in the lateral view lies on the threaded bar, as is visualized in the lateral view of the construction of the machine tool 100 in FIG. 5. Should the drive mechanism 20 have only one drive 21 and one gearbox 22 for the vertical positioning of the machining unit 10, the centre of gravity 101 would thus lie substantially in the one threaded bar in order for the entire weight of the machining unit 10 to stress the threaded bar in terms of traction/compression in a uniform manner and independently of the Z-position, even in the absence of any guide 18, 32. When two threaded bars are provided (cf. FIG. 3), the effective point 12 of the suspension is exactly between the suspension points 11, and the centre of gravity 101 would thus lie substantially between the threaded bars in order for the entire weight of the machining unit 10 to stress the threaded bars in terms of traction/compression in a uniform manner and independently of the Z-position, even in the absence of any guide 18, 32.

This has the advantage that the guide 18, 32 is de-stressed to a significant degree, since in the vertical relocation of the machining unit 10 and in the various positions of the machining unit 10 substantially no torque is generated by virtue of the spacing of the suspension 11 (coinciding with an effective point 12 of the suspension 11) from the centre of gravity 101. The guide 18, 32 of the machining unit 10 can thus be conceived for significantly lower loadings, and/or else guarantee a higher guiding precision of the machining unit 10 across the entire guided length during the vertical positioning of the machining unit 10.

On account of the construction of the machine tool 100 according to the invention there is a quasi-separation between the absorption of the load and the guiding precision. As opposed thereto, in the case of a conventional construction the guiding precision and a majority of the absorption of the load is established by the respective guide. This can result in a deformation of the guide in the repositioning of relocatable masses or loads, respectively, along the guide, when the loads have to be largely absorbed by the guide. By virtue of a guide never being able to be configured so as to be infinitely rigid, a compromise has always to be found between the precision of guiding and the absorption of load in the case of a conventional construction.

On account of the machine tool 100 according to the invention, such a compromise can be largely evaded since the entire load/mass of the machining unit 10 bears on the drive mechanism 20 (or on the threaded bar of the gearbox 22, respectively, as is shown in FIG. 5), specifically such that the centre of gravity 101 of the machining unit 10 lies in the threaded bar. On account thereof, the creation of a torque by virtue of the spacing of the suspension 11 (coinciding with the effective point 12 of the suspension 11) from the center of gravity 101 is evaded, said torque having to be absorbed by the guide 18, 32. On account thereof, the guide 18, 32 needs to absorb only significantly lower loads for the vertical positioning of the machining unit 10, this leading to a significant improvement in the guiding precision across the entire length of the guide 18, 32.

Apart from the construction of the drive mechanism 20 having a drive 21 and a gearbox 22, for example two or more drives 21 and correspondingly two or more gearboxes 22 can also be present for the vertical positioning of the machining unit 10. This would lead to the effective point 12 of the suspension 11 lying substantially in the centre of the respective distribution of the suspensions 11 (cf. FIGS. 6b and 6c, for example). The centre of gravity 101 of the machining unit 10 in this instance would be positioned such that the centre of gravity 101 of the machining unit 10 and the effective point 12 of the suspension 11 have a common vertically oriented straight line 23. The centre of gravity 101 of the machining unit 10 in this instance can move along said vertically oriented straight line 23 during the vertical positioning of the machining unit 10 without any substantial torque by virtue of a spacing of the vertically oriented straight line 23 from the centre of gravity 101 being created herein, said torque having to be absorbed by the guide 18, 32.

However, the machine tool 100 according to the invention can also be constructed in the manner that the drive mechanism 20 having at least one drive 21 and at least one gearbox 22 is fastened to the support portion 30 such that the suspension 11 is fastened to the machining unit 10 and in a vertical positioning of the machining unit 10 is relocated conjointly with the machining unit 10.

Apart from the design embodiment of the drive mechanism 20 having a threaded bar, the drive mechanism 20 can also be embodied as a combination of a rack and a gear wheel. A drive 21 herein would (for example, electrically, hydraulically or pneumatically) set the gear wheel in rotation and, on account thereof, move the rack in a corresponding translatory manner.

A substantial difference as compared to the embodiment of the drive mechanism 20 having the threaded bar herein lies in that both the drive mechanism 20 as well as the effective point 12 of the suspension 11, said effective point 12 in this case being the contact point between the pitch circle of the gear wheel and the pitch line of the rack, either maintain the position thereof relative to the support portion 30, the drive mechanism 20 in this instance being fastened to the support portion 30, or relative to the machining unit 10, the drive mechanism 20 in this instance being fastened to the machining unit 10.

The machining unit 10 furthermore has a spindle carrier 13 on which a work spindle 16 is provided. By way of the latter a clamped workpiece which is clamped, for example, on a machine table or on or in another device, respectively, can be machined in a manner corresponding to a program for controlling the numerically controllable axes of the machine tool 100 by way of the actuation of the machining unit 10.

The spindle carrier 13 can furthermore have a pivot device 14 by way of which a pivotable portion 15 of the spindle carrier 13 in which the work spindle 16 is provided can be pivoted according to a pivot axis 17.

The pivot axis 17 herein can enable the pivotable portion 15 of the spindle carrier 13 to be pivoted in an angular range from +90° to −90°. A further embodiment of the pivot device 14 having a respective pivot axis 17 can be that the pivot axis 17 is aligned at an angle of preferably 45° in relation to the vertically oriented straight line 23, or to the spindle axis of the work spindle 16, respectively. On account thereof, the spindle axis of the work spindle 16 which is provided in the pivotable portion 15 of the spindle carrier 13 can be pivoted in an angular range from 0° to 90°.

The pivot axis 17 can particularly advantageously be aligned in such a manner that the common centre of gravity of the work spindle 16 and the pivotable portion 15 of the spindle carrier 13 is disposed in the intersection point of the pivot axis 17 and the vertically oriented straight line 23. On account thereof, the work spindle 16 can be pivoted about the pivot axis 17 without any repositioning of the common centre of gravity of the work spindle 16 and the pivotable portion 15 of the spindle carrier 13, and thus any repositioning of the centre of gravity (overall centre of gravity) of the machining unit 10 arising.

The machining unit 10, as is shown in the exemplary embodiment of FIG. 5, is guided by a guide 18, 32 having guide rails 18 that are rectangular in the cross section. The guide rails 18 herein are fixedly connected to the machining unit 10 such that said guide rails 18 follow a vertical positioning of the machining unit 10. Guide slides 32 which are fixedly connected to the support portion 30 guarantee reliable and precise guiding of the machining unit 10 relative to the support portion 30.

The design embodiment of the guide 18, 32 herein can be very varied. Apart from a rectangular cross section of the guide rails 18, a round or a triangular cross section, for example, can also be advantageous to the guide rails 18. The potential design embodiments mentioned are not exhaustive; they are to be understood only as examples.

Apart from the cross section of the rail 18, the shape of the guide slides 32 having to be chosen correspondingly, the type of the guide 18, 32 can also be designed in a highly variable manner. Apart from classic friction guides, so-called circulating ball guides can also be used, wherein the circulation of the ball herein is at all times provided in the guide slides 32. Said circulating ball guides have the advantage of being able to be embodied in a highly rigid manner and therein to have significantly lower coefficients of friction or resistance, respectively, than classic friction guides.

The support portion 30 can furthermore have a slide portion 31 by way of which the vertically guided machining unit 10 can be relocated along a horizontal direction. The slide portion 31 can furthermore be used as a support structure for the guide rails 18, or else as a support structure for the guide slides 32, and herein have drives 21 and gearboxes 22 both for the vertical positioning of the machining unit 10 as well as drives and gearboxes for the horizontal positioning of the machining unit 10, wherein the slide portion 31 would be conjointly relocated during the horizontal positioning.

FIG. 6a schematically shows the effective point 12 of the suspension 11 when the drive mechanism 20 has one gearbox 22 (here a screw drive). On account thereof, the effective point 12 of the suspension 11 is located directly in the screw drive (threaded bar) such that the centre of gravity 101 of the machining unit 10 is either advantageously placed directly in the effective point 12, or else lies at least on the vertically oriented straight line 23 (not shown in FIG. 6a, cf. to this end FIG. 5). On account of the vertical positioning of the machining unit 10, the centre of gravity 101 of the machining unit 10 is guided along the vertically oriented straight line 23 and thus generates either a consistent or a negligibly minor torque in the respective guides (for example, the guide 18, 32) of the machine tool 100.

FIG. 6b schematically shows the effective point 12 of the suspension 11 when the drive mechanism 20 has two gearboxes 22 (here two screw drives). On account thereof, the effective point 12 of the suspension 11 is located substantially in the centre of the two suspensions 11 (having the suspension points thereof which are located substantially in the centre of the threaded bar), such that the effective point 12 has the substantially identical spacing (L1=L2) from the suspensions 11. On account thereof, the centre of gravity 101 of the machining unit 10 can either be advantageously placed directly in the effective point 12, or else lie at least on the vertically oriented straight line 23 (not shown in FIG. 6b, cf. to this end FIG. 5). By virtue thereof, the vertical positioning of the machining unit 10, the centre of gravity 101 of the machining unit 10 here too can be guided along the vertically oriented straight line 23, and on account thereof also generates either a consistent or a negligibly minor torque in the respective guides (for example, guide 18, 32) of the machine tool 100.

FIG. 6c schematically shows the effective point 12 of the suspension 11 when the drive mechanism 20 has three gearboxes 22 (here screw drives). On account thereof, the effective point 12 of the suspension 11 is located substantially in the centre of the spatial distribution of the three suspensions 11 (having the suspension points thereof which are located substantially in the centre of the threaded bar), such that the effective point 12 has the substantially identical spacing (L1=L2=L3) from the suspensions 11. By virtue thereof, the centre of gravity 101 of the machining unit 10 can either be advantageously placed directly in the effective point 12, or else lie at least on the vertically oriented straight line 23 (not shown in FIG. 6b, cf. to this end FIG. 5). The centre of gravity 101 of the machining unit 10 also at this point, on account of the vertical positioning of the machining unit 10, can be guided along the vertically oriented straight line 23, and here too generates either a consistent or a negligibly minor torque in the respective guides (for example, guide 18, 32) of the machine tool 100.

The location of the effective point 12 in the case of an embodiment of the drive mechanism 20 having a gear-and-rack combination would be comparable with a view to the location of the effective point 12 in the case of a screw drive, as shown in FIGS. 6a to 6c. This means that in the case of a rack and of a gear wheel, the effective point 12 of the suspension 11 would lie directly on the contact point of the pitch circle of the gear wheel and of the pitch line of the rack (cf. to this end FIG. 6a and the respective description), that in the case of two racks and correspondingly of two gear wheels, the effective point 12 of the suspension 11 would lie substantially in the centre (L1=L2) of the contact points of the pitch circle of the gear wheels and of the pitch line of the racks (cf. to this end FIG. 6b and the respective description), and that in the case of three racks and correspondingly of three gear wheels, the effective point 12 of the suspension 11 would lie substantially in the centre (L1=L2=L3) of the spatial distribution of the contact points of the pitch circle of the gear wheels and of the pitch line of the racks (cf. to this end FIG. 6c and the respective description), and thus would generate either a consistent or a negligibly minor torque in the respective guides (for example, guide 18, 32) of the machine tool 100.

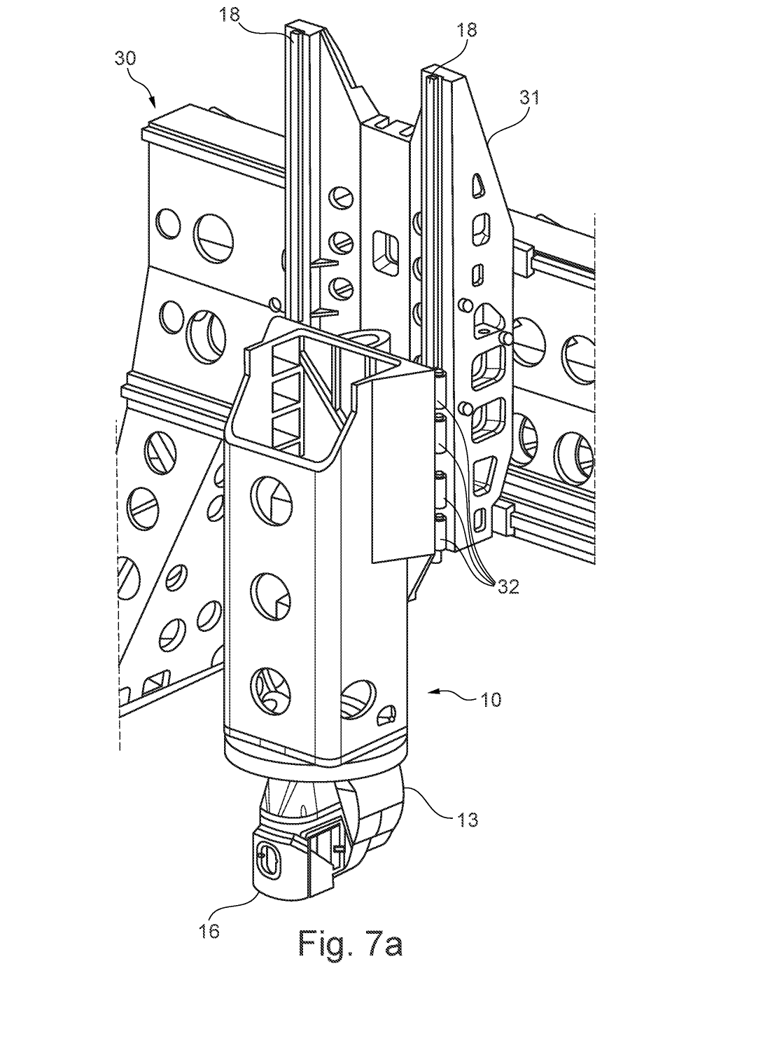

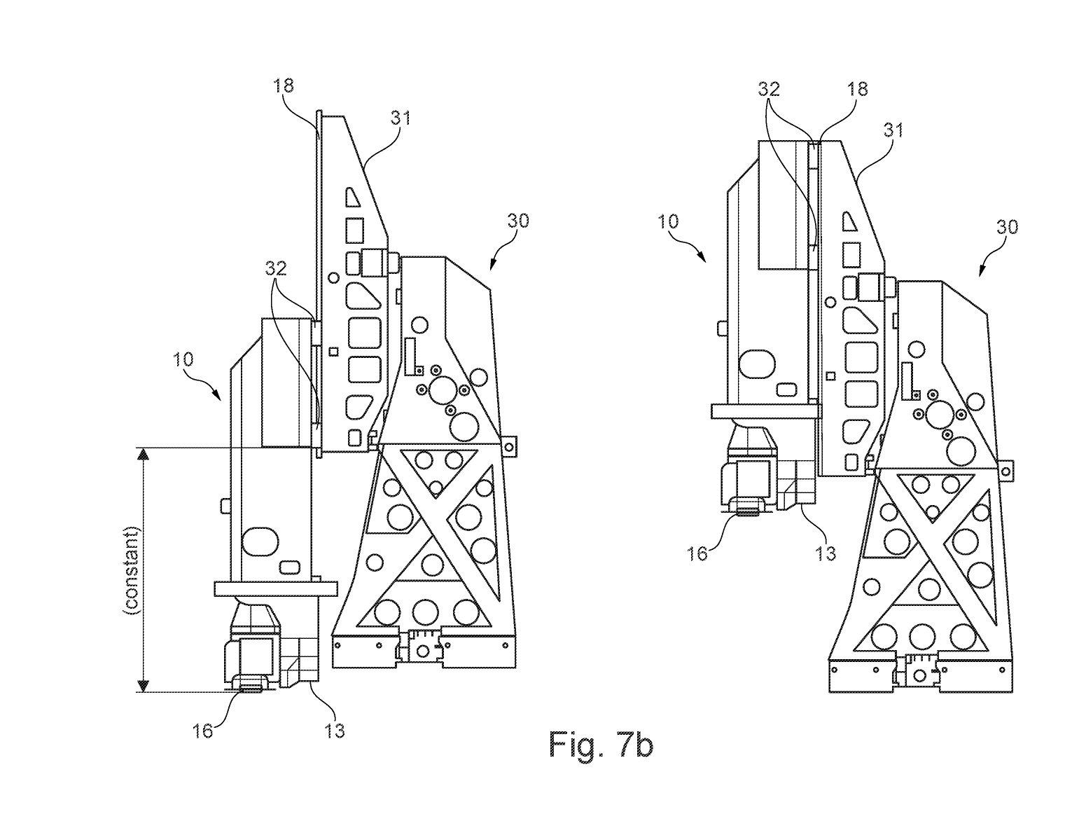

FIG. 7a schematically shows an embodiment of the machine tool 100 according to the invention, having a modified arrangement of the vertical guide 18, 32. The drive mechanism 20 having one drive 21 and one gearbox 22 herein is not shown in FIG. 7a, so as to be able to somewhat better see the design embodiment of the modified vertical guide 18, 32.

The guide 18, 32 has been modified such that the guide slides 32 are now fastened to the machining unit 10 such that said slide guides 32 in a vertical positioning of the machining unit 10 are conjointly relocated. The guide rails 18 are therefore fastened in a corresponding manner to the support portion 30 or to the slide portion 31.

In the case of such a design embodiment of the guide 18, 32 the advantage lies in that the vertical spacing of the work spindle 16 that is held in the spindle carrier 13, or of a tool that is received from the work spindle 16, respectively, is always consistent in relation to the guide slides 32 such that the latter in any arbitrary position of the machining unit 10 function as support points. Should forces that act in a horizontal direction, for example, be created on the tool, the machining unit 10 behaves like a deforming structure which by way of the support points (here the guide slides 32) is fixedly connected to the support portion 30 or to the slide portion 31.

In the case of known forces which act on the tool, for example, and in the case of known structural conditions of the machining unit 10, the rigidity behaviour of the machining unit 10 can now be advantageously very readily predicted. Since the support points (guide slides 32) always have the same position in relation to the machining unit 10, the rigidity behaviour of the machining unit 10 is consistent in all vertical positions of the machining unit 10 relative to the support portion 30/slide portion 31, since no modification of the spacing between the work spindle 10, or the tool that is received in the work spindle 10, respectively and the support points (guide slides 32) is performed. This now enables a very precise correction of the numerically controlled axes, independently of the vertical positioning of the machining unit 10.

FIG. 7b schematically shows an embodiment of the machine tool 100 according to the invention, having a modified arrangement of the vertical guide 18, 32 in the lateral view. The drive mechanism 20 having one drive 21 and one gearbox 22 is also not shown herein in FIG. 7b, so as to be able to somewhat better see the design embodiment of the modified vertical guide 18, 32.

As compared to FIG. 7a, the machining unit 10 in FIG. 7b is additionally shown in two different vertical positions, wherein the machining unit 10 in the illustration on the left can be seen in a vertically lower position, and the machining unit 10 in the illustration on the right can be seen in a vertically upper position.

When comparing the two illustrations it can be seen how the guide slides 32 follow the machining unit 10 in the respective vertical position of the latter, and on account thereof the spacing between the work spindle 16, or of a tool that is received in the work spindle 16, respectively, from the guide slides 32 is at all times consistent. This leads to the always identical rigidity behaviour in the case of known forces, independently of the vertical position of the machining unit 10, as has already been described hereabove.

### LIST OF REFERENCE SIGNS

10 Machining unit
11 Suspension
12 Effective point of the suspension
13 Spindle carrier
14 Pivot device
15 Pivotable portion of the spindle carrier
16 Work spindle
17 Pivot axis
18 Guide rail (Z-guides)
20 Drive mechanism
21 Drive (Z-drive)
22 Gearbox (threaded bars)
23 Vertically oriented straight line
30 Support portion
31 Slide portion
32 Guiding slides
50 Suspension portion
60 Gantry portion
61 Guides (Y-guides)
62 Threaded bar
63 Y-drive
70 Machine bed
71 Guides (X-guides)
72 Threaded bars
73 X-drive
80 Workpiece clamping table
100 Machine tool
101 Centre of gravity of the machining unit

1. Machine tool for machining a workpiece, comprising:
a support portion on which at least one vertical guide is disposed,
a machining unit for machining a workpiece on the machine tool, said machining unit being guided so as to be vertically movable on the at least one vertical guide of the support portion,
a drive mechanism having at least one drive and at least one gearbox, said drive mechanism being specified for driving a relocation of the machining unit in the vertical direction along the at least one vertical guide of the support portion,
wherein the machining unit is suspended from one or a plurality of gearbox portions of the at least one gearbox of the drive mechanism in such a manner that the centre of gravity of the machining unit conjointly with an effective point of the suspension of the machining unit on the drive mechanism is disposed in a common vertically oriented straight line.

2. Machine tool according to claim 1, wherein
the effective point of the suspension in the case of one gearbox is disposed in the suspension per se, and in the case of a plurality of gearboxes is disposed substantially in the centre of individual suspensions which form the suspension in the case of a plurality of gearboxes.

3. Machine tool according to claim 1, wherein
the machining unit is suspended from the one or the plurality of gearbox portions of the at least one gearbox of the drive mechanism in such a manner that a consistent torque acts on the support portion during the relocation in the vertical direction.

4. Machine tool according to claim 1, wherein
the machining unit is suspended from the one or the plurality of gearbox portions of the at least one gearbox of the drive mechanism in such a manner that substantially no torque acts on the at least one vertical guide of the support portion during the relocation in the vertical direction.

5. Machine tool according to claim 1, wherein
the drive mechanism is disposed in such a manner that the drive mechanism maintains the position thereof relative to the support portion during the relocation of the machining unit, and the position of the effective point of the suspension relative to the machining unit remains substantially consistent.

6. Machine tool according to claim 1, wherein
the drive mechanism is disposed in such a manner that the drive mechanism maintains the position thereof relative to the machining unit during the relocation of the machining unit, and the position of the effective point of the suspension relative to the support portion remains substantially consistent.

7. Machine tool according to claim 1, wherein
both the drive mechanism as well as the effective point of the suspension are disposed in such a manner that the two former maintain the position thereof relative to the support portion during the relocation of the machining unit.

8. Machine tool according to claim 1, wherein
both the drive mechanism as well as the effective point of the suspension are disposed in such a manner that the two former maintain the position thereof relative to the machining unit during the relocation of the machining unit.

9. Machine tool according to claim 1, wherein
the effective point of the suspension and/or the centre of gravity of the machining unit move/moves along the vertically oriented straight line during the relocation of the machining unit.

10. Machine tool according to claim 1, wherein
the drive mechanism is configured as a self-locking drive mechanism.

11. Machine tool according to claim 10, wherein
the drive mechanism comprises at least one screw drive, preferably at least one ball screw drive.

12. Machine tool according to claim 11, wherein
in the case of one gearbox the at least one vertical guide of the machining unit is disposed in such a manner that the centre of gravity of the machining unit is displaced in a manner substantially concentric with a threaded bar of the screw drive, in particular along the vertically oriented straight line, in the relocation of the machining unit.

13. Machine tool according to claim 12, wherein
the threaded bar is disposed so as to be axial to the vertically oriented straight line.

14. Machine tool according to claim 1, wherein
the drive mechanism comprises at least one gear-and-rack combination, preferably at least one helical-cut gear-and-rack combination.

15. Machine tool according to claim 14, wherein
in the case of one gearbox the at least one vertical guide of the machining unit is disposed in such a manner that the centre of gravity of the machining unit is guided substantially at the contact point of the pitch circle of the gear wheel and the pitch line of the rack in the relocation of the machining unit.

16. Machine tool according to claim 1, wherein
the machining unit comprises a spindle carrier that supports a work spindle.

17. Machine tool according to claim 16, wherein
the spindle carrier comprises a pivot device for pivoting the work spindle about a pivot axis.

18. Machine tool according to claim 17, wherein
the pivot axis is disposed so as to perpendicular or oblique, preferably at an angle of 45°, in relation to a spindle axis of the work spindle.

19. Machine tool according to claim 1, wherein
a pivotable portion of the spindle carrier which holds the work spindle and by way of which the work spindle is pivotable about the pivot axis is disposed in such a manner that a common centre of gravity of the pivotable portion and of the work spindle lies in the intersection point of the pivot axis and of the vertically oriented straight line.

20. Machine tool according to claim 1, wherein
the support portion is configured as a machine stand that is disposed on a machine bed.

21. Machine tool according to claim 1, wherein
the support portion comprises a slide portion that is mounted so as to be horizontally relocatable.

22. Machine tool according to claim 21, wherein
the slide portion is disposed so as to be mounted on guides on a horizontally relocatable gantry construction of a gantry machine tool.
